(19) United States
(12) Patent Application Publication
(10) Pub. No.: US 2015/0293678 A1
(43) Pub. Date: Oct. 15, 2015

(54) STORY BOARD SYSTEM AND METHOD

(71) Applicant: MILNAA, INC., Sunnyvale, CA (US)

(72) Inventor: Steve Chainani, Sunnyvale, CA (US)

(21) Appl. No.: 14/420,840

(22) PCT Filed: Aug. 12, 2013
(86) PCT No.: PCT/US13/54577

§ 371 Date: Feb. 10, 2015

Related U.S. Application Data
(60) Provisional application No. 61/681,831, filed on Aug. 10, 2012.

(51) Int. Cl. G06F 3/0484; G06Q 10/10; G06Q 30/02; G06Q 50/00

(52) U.S. Cl. CPC G06F 3/04847; G06Q 50/01; G06Q 10/1093; G06Q 30/0269

(57) ABSTRACT

A story board system and method are provided that may be implemented as a feature of a social networking system and method.

### PRIORITY CLAIMS/RELATED APPLICATION

This application claims the benefit under 35 USC 119(e) and 120 to U.S. Provisional Patent Application No. 61/681,831, filed on Aug. 10, 2012 and titled “Story Board System And Method”, the entirety of which is incorporated herein by reference.

### FIELD

The disclosure relates generally to a story board system and method.

### BACKGROUND

Facebook has a first generation Timeline that gives you a 2 Dimensional profile image and some text. You have to scroll painfully slowly page by page backwards in time to see your prior social media Postings. The images are of low resolution and only in 2 dimensions.

Thus, it is desirable to provide a story board system and method and it is to this end that the disclosure is directed.

### BRIEF DESCRIPTION OF THE DRAWINGS

FIG. 1 illustrates an example of an implementation of a story board system;

FIGS. 2-6 illustrate a process for posting on the storyboard system;

FIGS. 7-8 illustrate a process for viewing on the storyboard system;

FIG. 9 illustrates a set of technology and processing layers of the story board system;

FIG. 10 illustrates a relationship between the story board system and a user profile;

FIG. 11 illustrates usage of the story board component in a larger system for social networking;

FIG. 12 illustrates a set of functional modules of the story board system used during the posting process;

FIGS. 13A and 13B illustrate an activity data flow of the story board system;

FIG. 14 illustrates a set of functional modules of the story board system used during the viewing process;

FIG. 15 illustrates a set of functional modules of the story board system used while opening a post in the story board system; and

FIGS. 16-19 illustrates examples of the user interface of the story board system for a public storyboard, a family storyboard, a friends storyboard and a business storyboard, respectively.

### DETAILED DESCRIPTION OF ONE OR MORE EMBODIMENTS

The disclosure is particularly applicable to a web-based story board system and method that may be implemented within a Milnaa social networking system and it is in this context that the disclosure will be described. It will be appreciated, however, that the system and method has greater utility since the system and method may be implemented in other manners that are within the scope of the disclosure.

The Milnaa Storyboard and Infinite Slider allow you to instantaneously view your postings by merely scrolling your mouse over the appropriate bar on the slider. Each posting is format agnostic and may be, for example in 2D, 3D, Video, Audio, Text or any type of file attachment or any combination of the above. Furthermore, each post may have other web-links, events, forums, groups, text, audio, video, 3D files or any attachments as well as links to “shared workspaces.” The workspace is a feature of the system that is like a “drop box” where the user who originated the posts (the Post's originator) can deposit any type of file and thereafter a designated recipient can remove the file, work on it or amend it, then re-deposit back into the “Workspace” so that the workspace is a collaboration tool. The Milnaa postings are a rich, next generation collection of advanced multi-media technologies combined using innovative software techniques for a unified viewer experience facilitating a whole new level of User interactions and advertising delivery methodologies, never done before.

In one implementation, the storyboard is a feature of the Milnaa social networking system (“MILNAA”) that is described in U.S. Provisional Patent Application Ser. No. 61/613,435 filed on Apr. 2, 2012 which is incorporated herein by reference. In one embodiment, the feature may used the Microsoft Dotnet Platform to develop web applications (“ASP.net”) and Microsoft Silverlight to develop Rich Internet Applications.

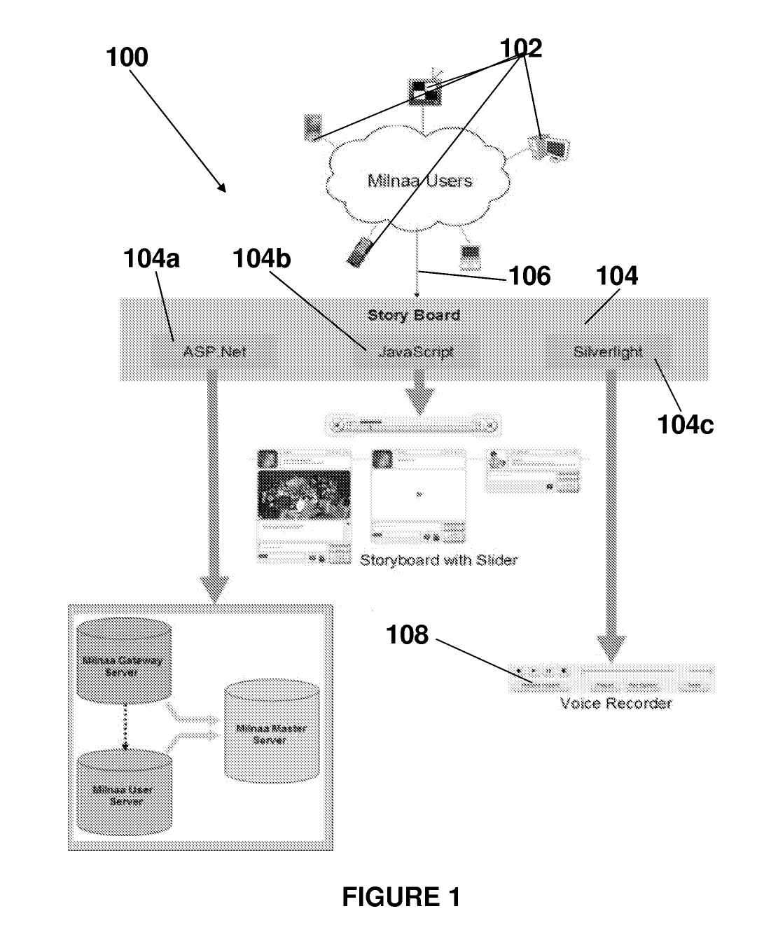

FIG. 1 illustrates an example of an implementation of a story board system 100 that may be implemented as a feature of the social networking system, such as the Milnaa social network system. The story board system is a one stop place to Post various things by a MILNAA user attaching Event, Forum, Comments, Photo album, etc. and then to publish it to all their connections, inside the world of Milnaa and also outside. The system may have one or more computing devices 102 that allow users of the social network system (Milnaa users) to interact with the story board system. Each computing device may be a processing unit based device with sufficient processing power, memory, connectivity (wired or wireless) and display capability to allow the user to connect to the system and interact with the system as described below in more detail. Each computing device may be, for example, a smartphone (Apple iPhone device, Blackberry RIM device, Android based device, etc.), a personal computer, a tablet computer, a cellular phone, etc. Each computing device 102 may interface with a story board system 104 over a link 106, such as the Internet, a computer network, a wireless data network and the like. Each computing device 102 may have and execute a browser application or an application resident on the computing device to interact with and displays the user interface images of the story board system as described in more detail below.

The story board system may be implemented by one or more computer resources, such as one or more server computers or one or more cloud resources, and may include an ASP.net portion 104a, a Javascript portion 104b and a Silverlight portion 104c. These elements may be part of a storyboard engine that implements the operations of the storyboard system including making a posting, viewing a storyboard and opening a specific post for a collection as described below in more detail. Each computing device 102 may execute a well known browser application and the storyboard viewing functionality of the system (using the Javascript portion) works in all major browsers and Operating System environments. The Silverlight portion 104c may be used to interface with a voice recorder component 108 and thus the audio capture feature requires the Microsoft Silverlight plugin (version 4 or latest) installed in the machine to capture the Mouthpiece of the computer system. The ASP.net portion 104a interfaces with the servers of the Milnaa social network system including, for example, a gateway server, a user server and a master server.

The system may thus provide one-touch multimedia recording using a web server with the web site (such as the storyboard website) with the computing devices 102. In typical systems, browser and browser components (HTML, HTML5) rely heavily on JavaScript to perform file uploads, but security restrictions against cross-site scripting (XSS) prohibit the JavaScript from populating the file input element of the HTML form with the name of a multimedia file without having the native file browser pop up. In the storyboard system, the web server sends a token in the upload page that can be scanned by the client using JavaScript. On selection of the option on a client, a recording device (camera, microphone, etc) is activated, and the output written to a local file. On completion (either due to timeout or due to the user activating a control such as a button), the client uploads the file to the server using a server-side dynamic page using the token passed above. This token permits the server to associate the upload with the current post. On the mobile computing devices 102, the multimedia recording using the native capabilities of the computing device so that the native file browser is bypassed completely. On desktop computing devices 102, a Java applet (not JavaScript) is used to perform the same function.

In one implementation, the story board system may use Microsoft C# and ASP.Net technologies on Microsoft.Net 4 as a framework for the programming language to develop the Storyboard. Microsoft Silverlight technology is used to capture the audio input of the user. The Story-board functionality can be used from any machine having a standard browser installed. To record the audio message in a Storyboard built-in system microphone or separate mouthpiece is needed what can be either handheld or attached to earphone. The data storage in the system may be implemented using SQL Server 2008 Database.

At a high level, the story board system and method has three functional components:
A. Making a Post to Story-board
B. Viewing Story-Board of any user
C. Opening a specific Post from the Collection on mouse click.

Making a Post

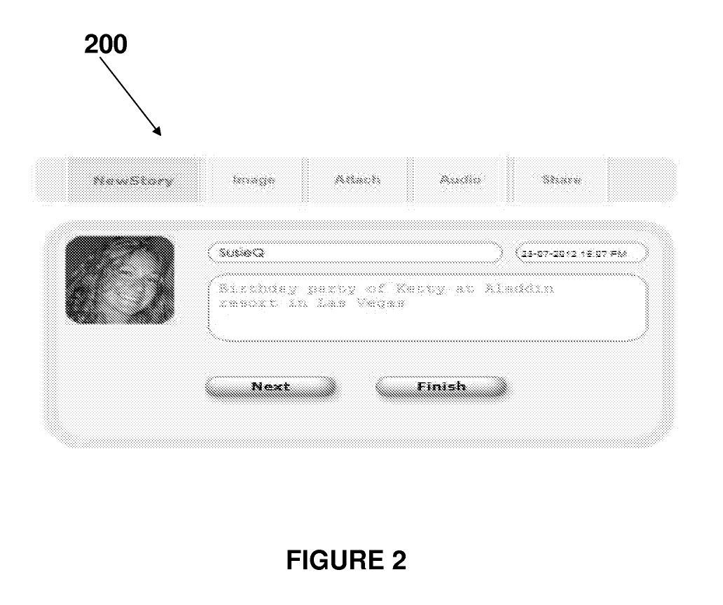

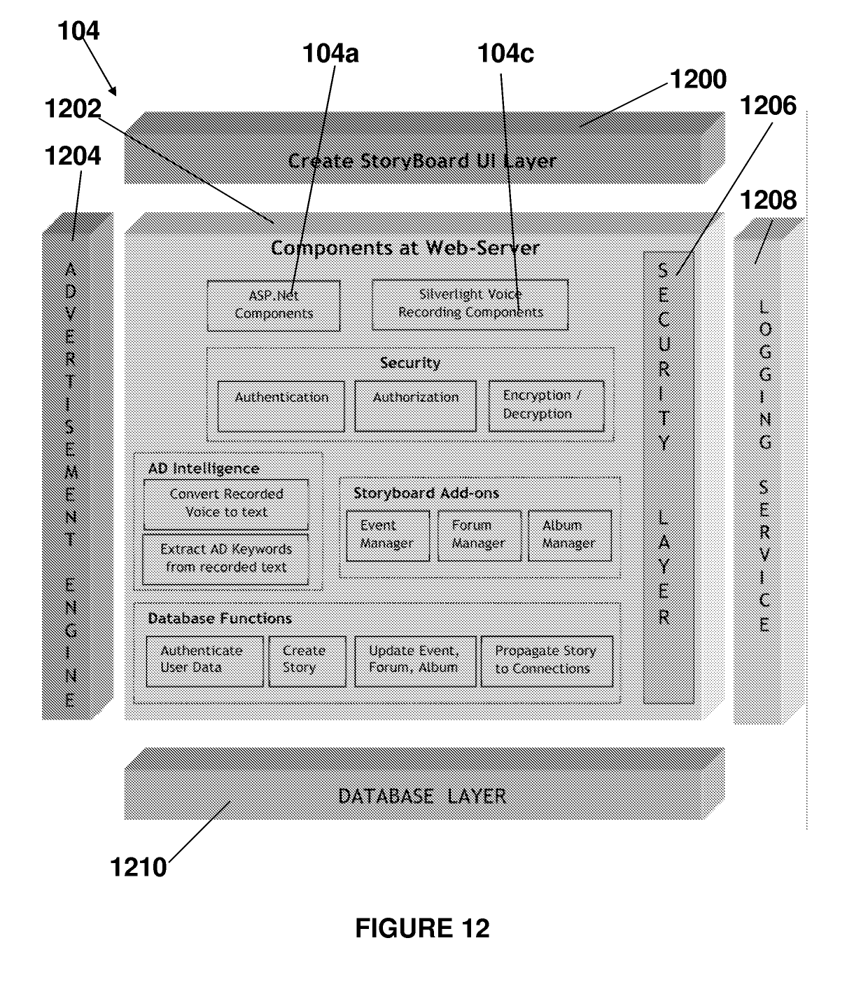

FIGS. 2-6 illustrate a process for posting on the storyboard system. The making a post process allows users to create a storyboard entry. The making a post process may be accomplished, in one embodiment, using one or more “entry” forms such as user interfaces generated on a web browser that is executing on the computing device. FIG. 12 illustrates a set of functional modules of the story board system 104 used during the posting process. The story board system may have a create storyboard user interface layer 1200, a web server portion 1202, an advertising engine 1204 (described below in more detail), a security layer 1206, a logging service portion 1208 and a database layer 1210 that operate together to provide the posting functionality of the story board system. As shown in FIG. 12, the web server portion 1202 may have the ASP module 104a and the Silverlight module 104c described above as well as security modules, advertising intelligence modules, storyboard add-on modules and database function modules.

While making a Post, one or more users can attach an event, forum or album to the post. For example, if the Post is about an birthday event, the user can attach a forum where the visitors can share their comments about that event. The user can also add Photo album(s) where the visitors can share the photos related to that event. In addition, people visiting the storyboard can share their comments on the post. In one embodiment, these features may be done in ASP.Net/C# frontend technology with SQL Server database at the backend.

In addition, while posting a story, the user(s) can attach a voice memo to it by recording their voice in it. The voice recording is then played when someone visits the Post. The posting of the story board may also allow the uploading an audio file during story creation which is played in the background. As described above, the functionality to record and play the audio recording may be implemented using Microsoft Silverlight technology.

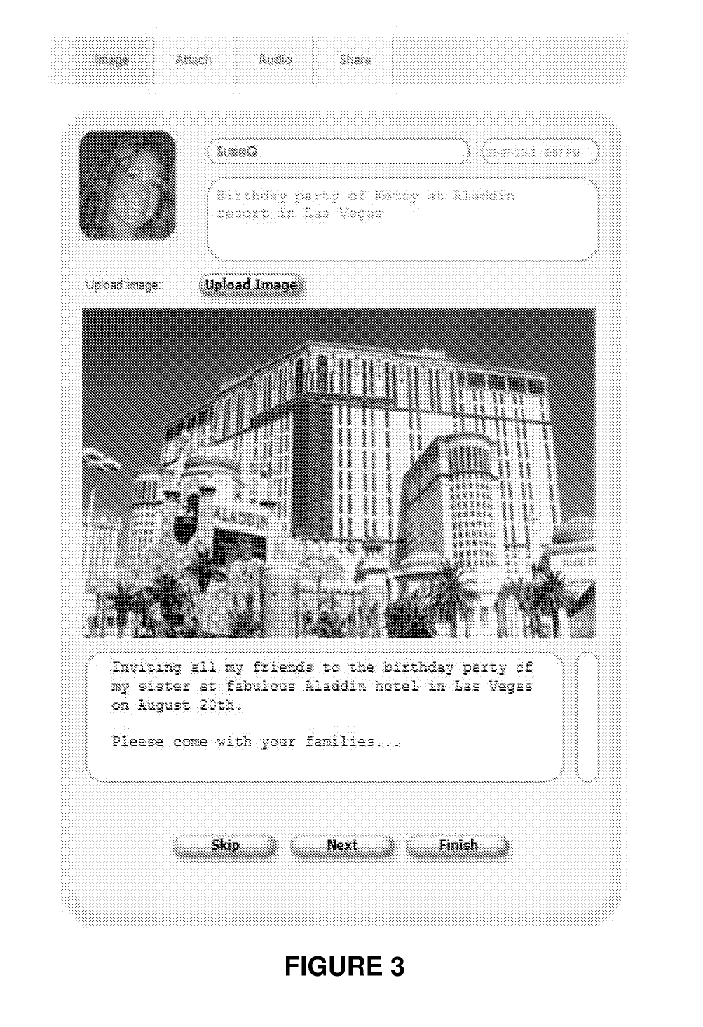

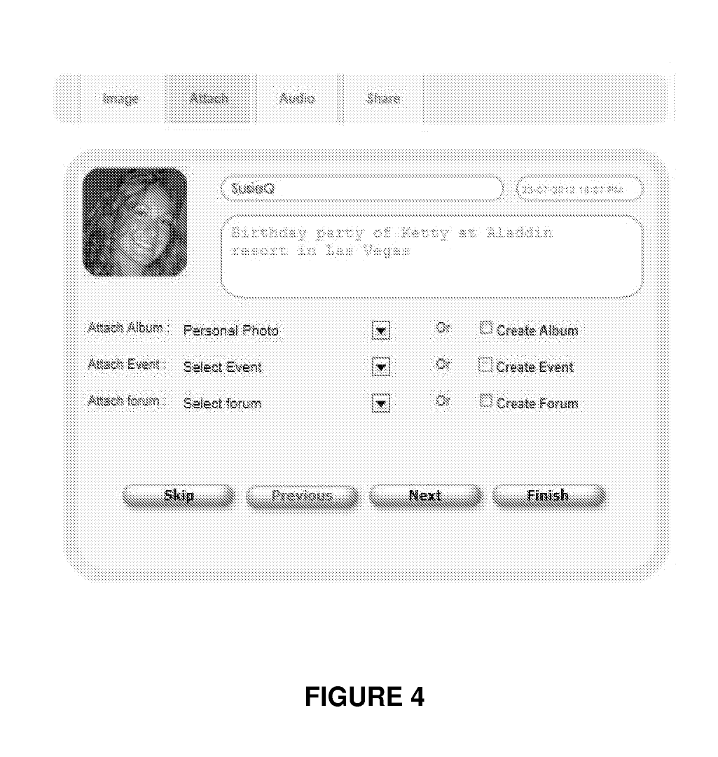

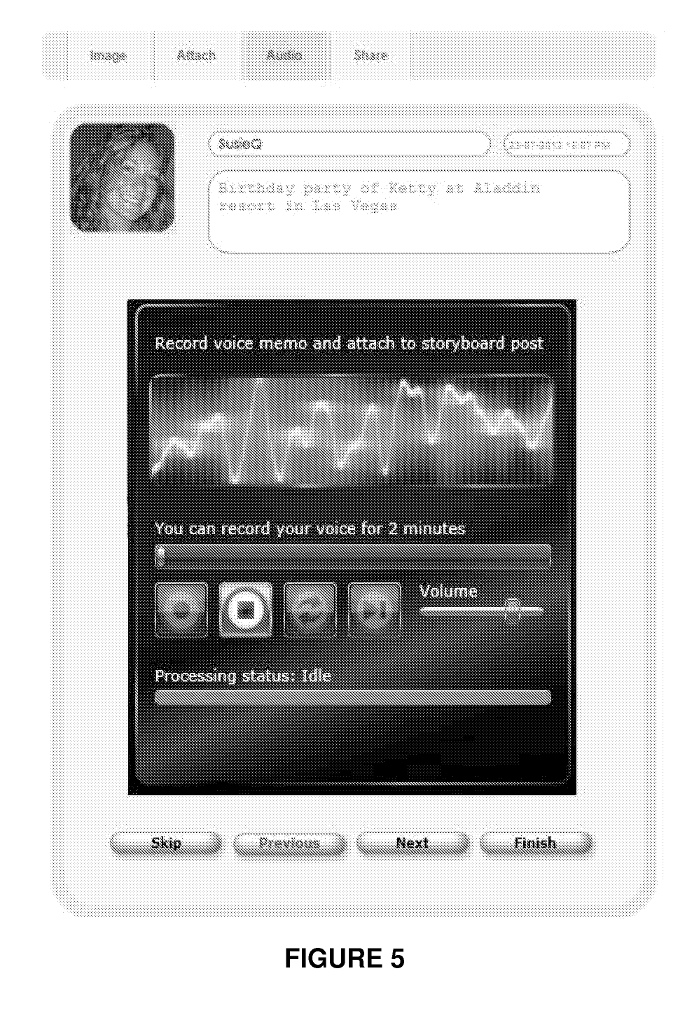

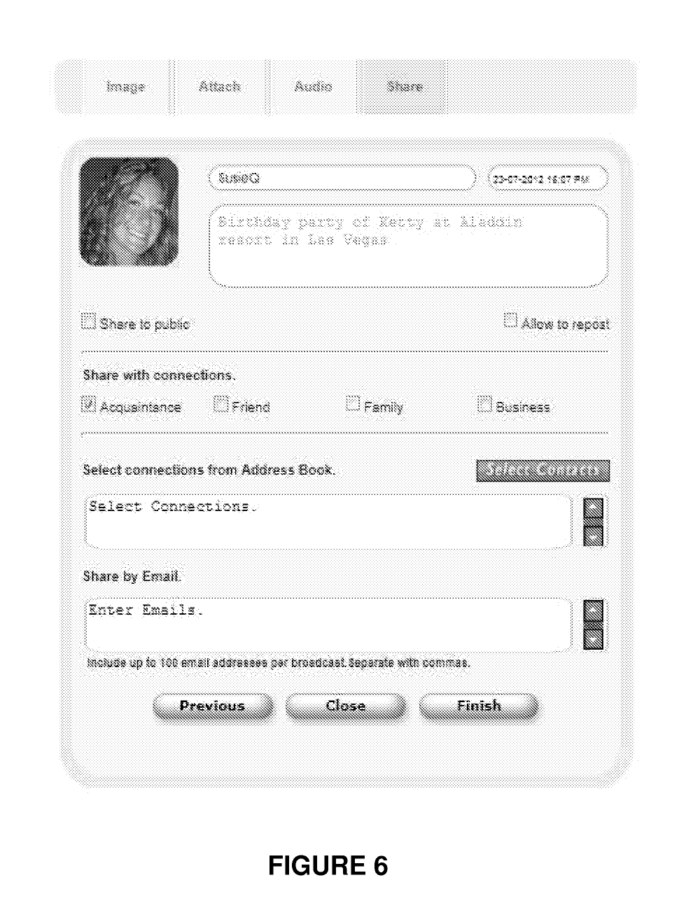

FIG. 2 illustrates an example of a user interface form 200 for posting to the story board. In this user interface, the user enters the basic information for the post and this is the minimum detail that is required to make a post. At this stage, the user can just enter it and finish the Post which would then be added to his/her storyboard. Alternately, the user can continue entering the other details in other user interfaces such as shown in FIG. 3. Using the user interface in FIG. 3, the user can select an image for the post and enter description for the post. The user can also skip this page to move to the next level. The user interface example in FIG. 4 allows the user to attach a photo or photo album, an event or a forum to attach to the post. The user interface example in FIG. 5 allows the user to record a voice memo straight from the computer microphone and attach the same with the Post. Using the user interface example in FIG. 6, the user can then pick the recipients for that particular post and send the notifications to them. As a result of the above process, the user can generate a new post.

Viewing the Story Board and a Post

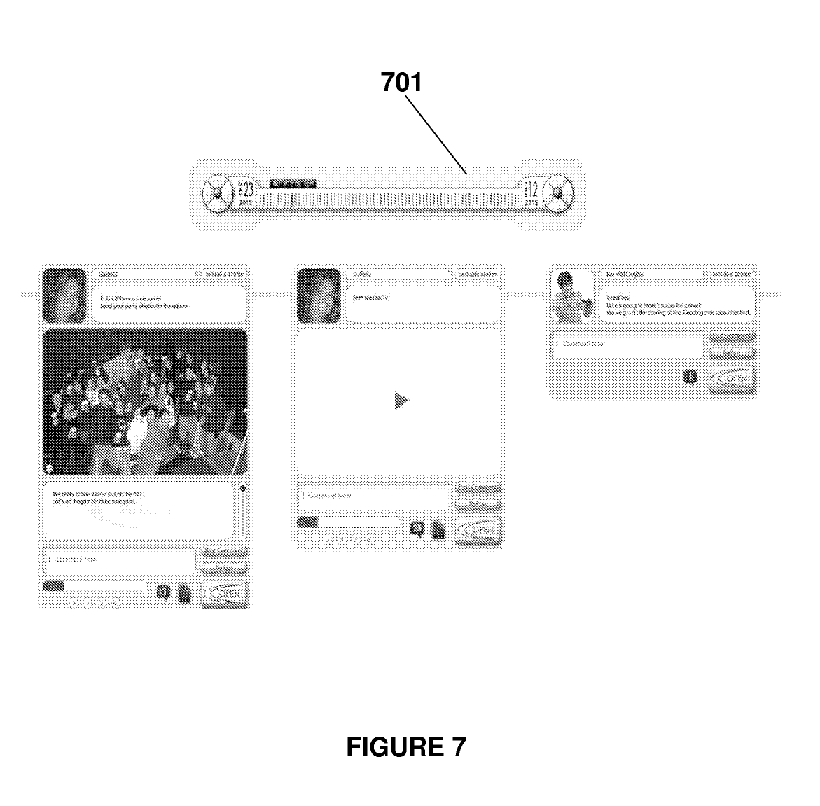

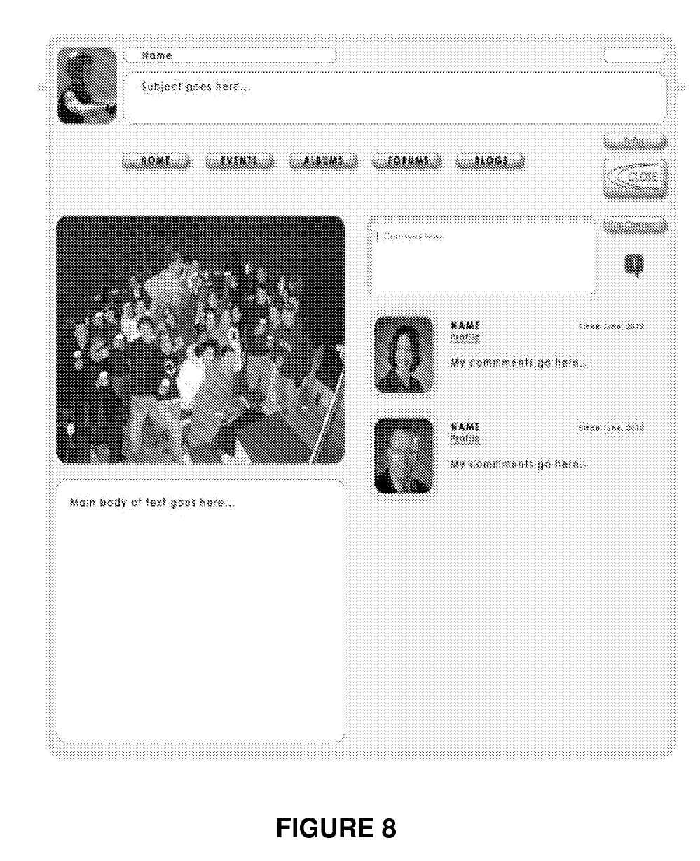

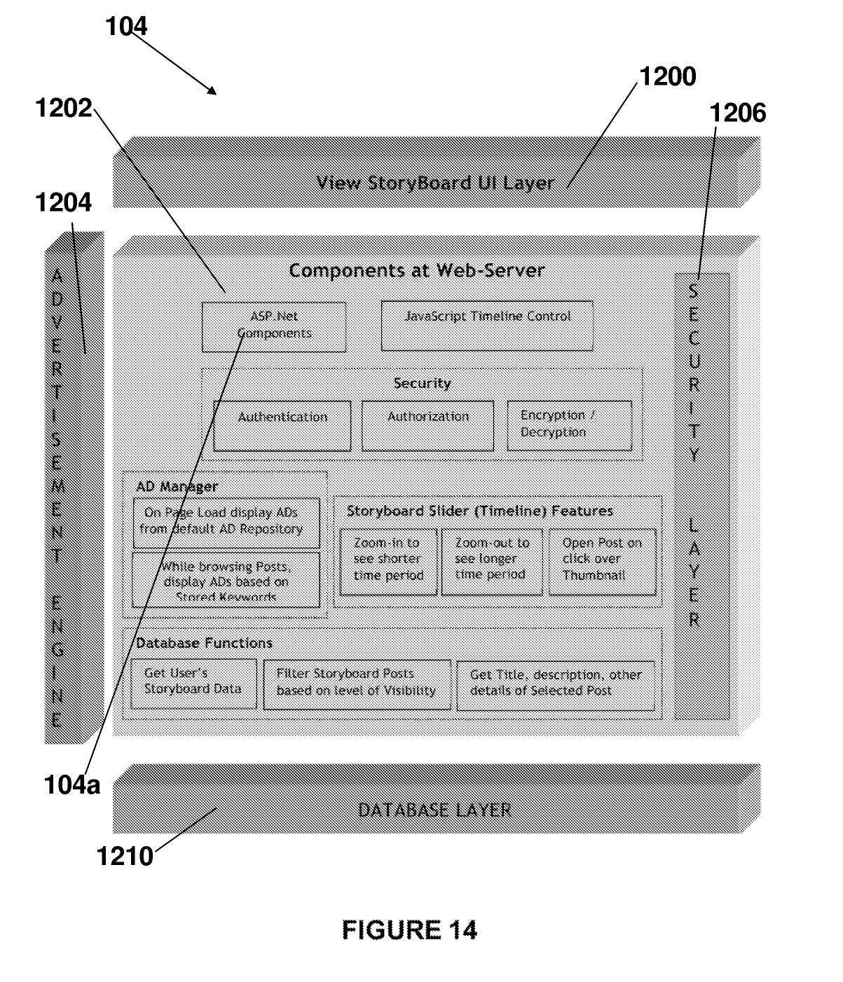

FIGS. 7-8 illustrate a process for viewing on the storyboard system and FIG. 14 illustrates a set of functional modules of the story board system used during the viewing process. As shown in FIG. 14, the story board system uses many of the same elements (marked with the same reference numbers) for the viewing process. To implement the viewing, the web server portion may also have a storyboard slider (timeline) portion. The viewing process allows a user to access the Storyboard of a user and to browse all Posts in the story board. A scrollbar 701 appears in the Storyboard of the user which indicates all individual Posts by the user, date and time wise. The list can be Zoomed-in and Zoomed-out to cover a broader or shorter timeframe.

In this Storyboard viewer utility, when a user clicks on a particular post, corresponding Post opens up on another page as shown in FIG. 7. For example, the Storyboard viewer shows the cover-photos with texts of the Stories with attached voice memo submitted by a user to everyone. However, to open the particular Post one would need to have proper permission. In the system, only those connections who were invited by the users in that Post can open that particular post. In the system, if a Post was entered as a Public post, the post can be opened by all users. Thus, in the system, the originating user of the post controls the access to the post, such as by using an access control component of the storyboard engine, so that the story board system is private and access is controllable. For example, in addition to the Public post, the system also may allow access to posts by friends, family or business level contacts or Post to a Custom list of contacts from an address book of the user. The posts of a user may be thought of as a private wall of the user and the user controls the access to the private wall.

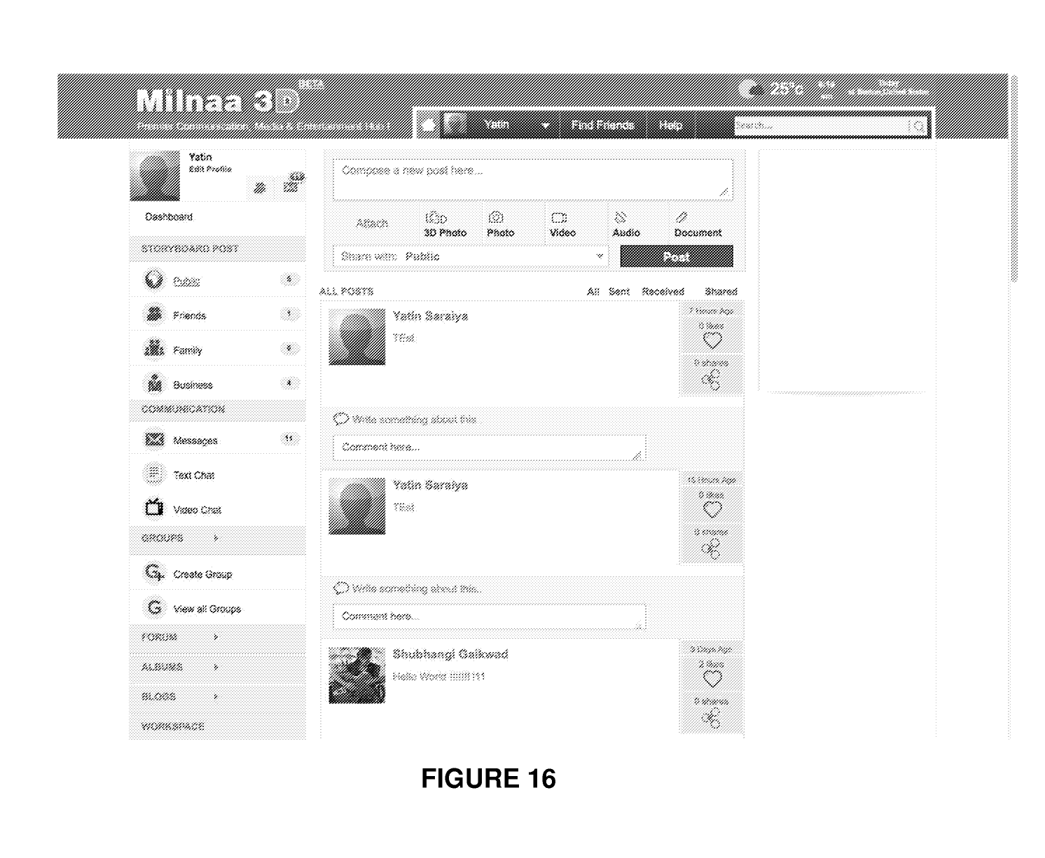

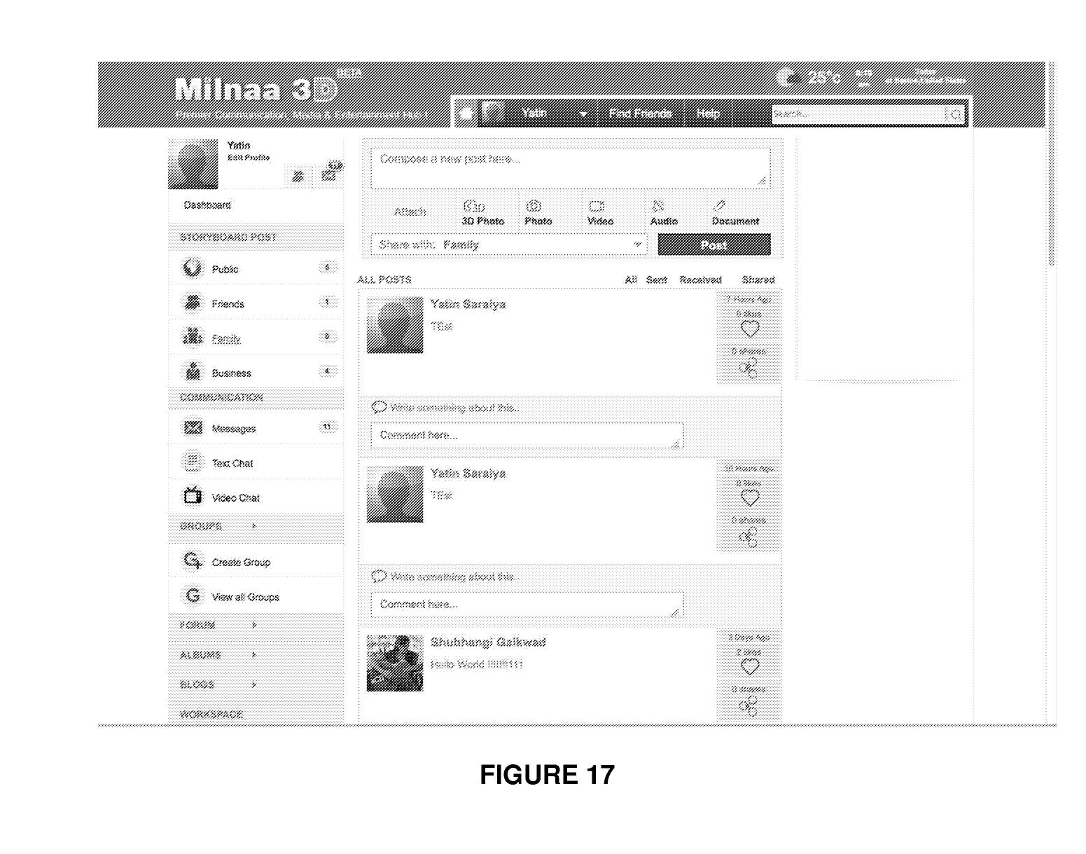

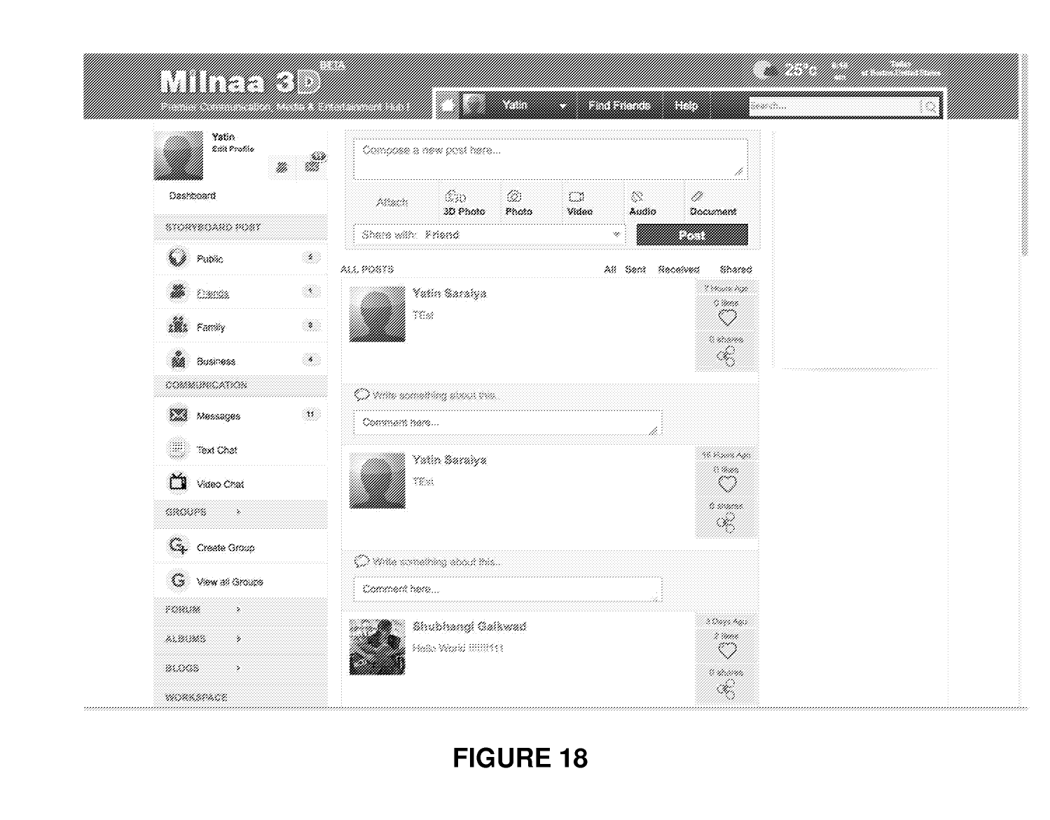

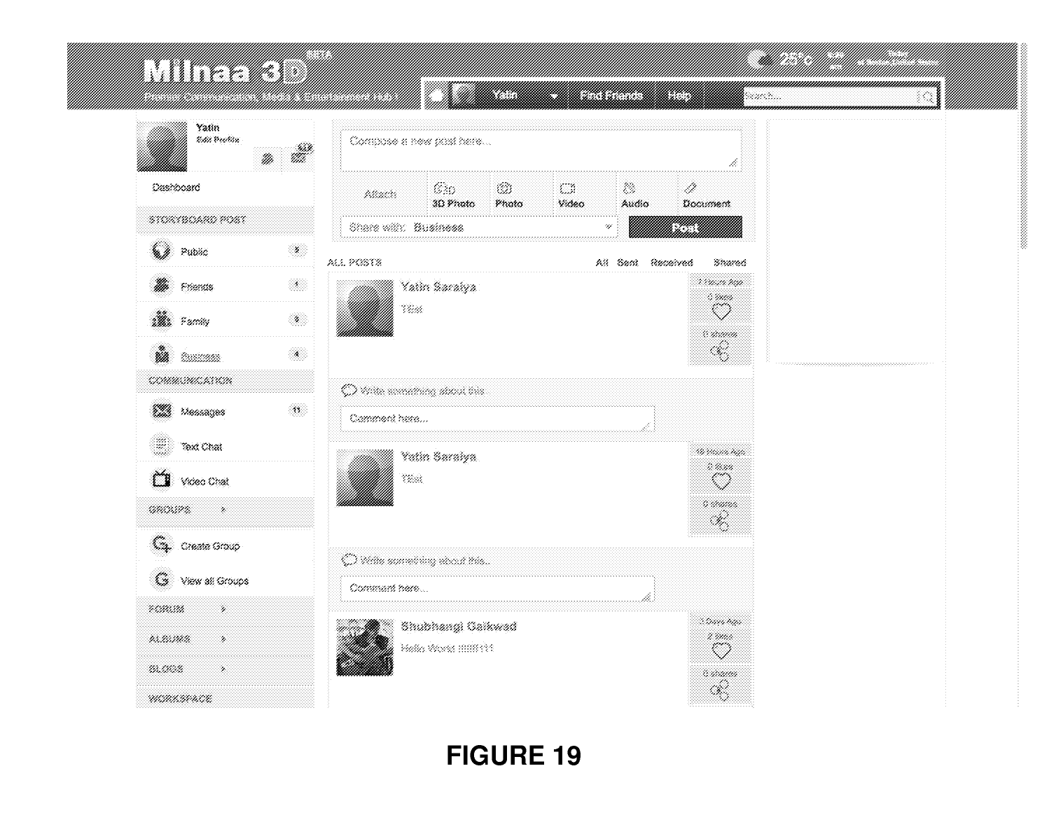

In one embodiment of the story board system, the public walls of the users (the posting that have been designated as accessible to the public by the originator) may scroll across a Home page of the system and visitors who have not logged-in can click to Open the Post (wall.) However, the visitors cannot write on any Wall unless they Sign Up as a member of the story board system. In the story board system, business Posts (Walls) can search resumes by key word, communicate with suppliers, customers, employees and investors. FIGS. 16-19 illustrates examples of the user interface of the story board system for a public storyboard (FIG. 16), a family storyboard (FIG. 17), a friends storyboard (FIG. 18) and a business storyboard (FIG. 19.) Each example of the user interface shows one or more posts in each story board along with a post button for posting a new post in the storyboard.

In the case of a Storyboard post that was sent to non-milnaa users through emails, a temporary password is assigned for those connections which are needed before the post can be accessed. The lifetime of the password is set only for a specific time and then the user is asked to join in Milnaa to have his/her continued access to that particular Post.

Once user clicks on a particular post on the Storyboard, a corresponding page opens up, an example of which is shown in FIG. 8. This page contains the actual content and all related items like Event(s), Forum(s), Photo-Album(s), which can be accessed by the user who opens it up. The recorded voice or audio, if present for the Post, is played at the background when the post opens up.

In the Forum page, all invitees of a post can share their comments, views. The invitees can open up album(s) to view photos in it. In addition, the invitees are allowed to contribute to the album by adding photos taken by them. If required, the Storyboard owner can hide certain Photos, Comments, shared by the invitees, if he/she feels the need for same.

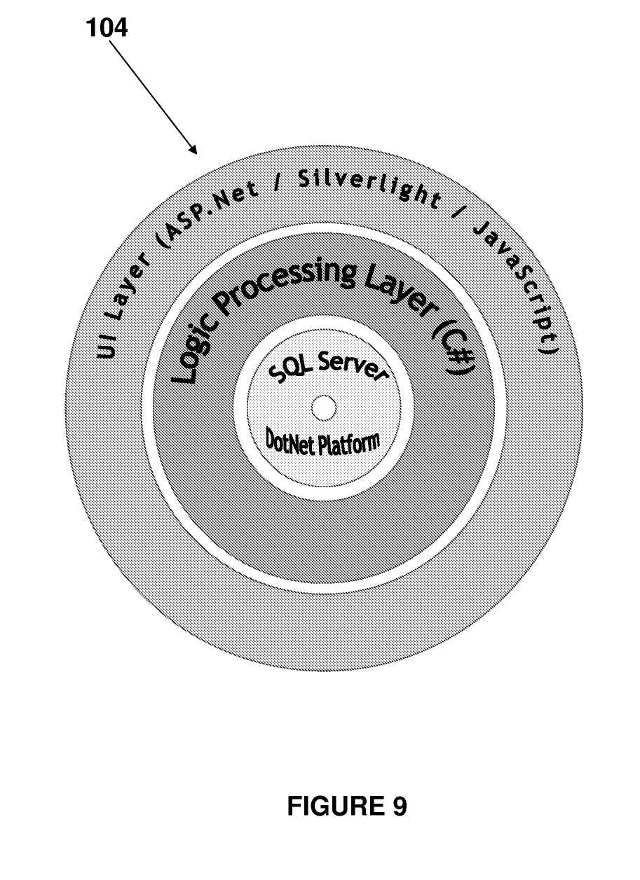

FIG. 9 illustrates a set of technology and processing layers of the story board system 104. The modularized architecture promotes easier reparability as errors are confined to few modules thus it is easier to locate and remove them. The initial design of the application or the successive changes is done keeping the modularity and evolve-ability of the software in mind The storyboard related functionalities are being packaged in the logical structure shown in FIG. 9 to make the functionality easy to locate and to modify.

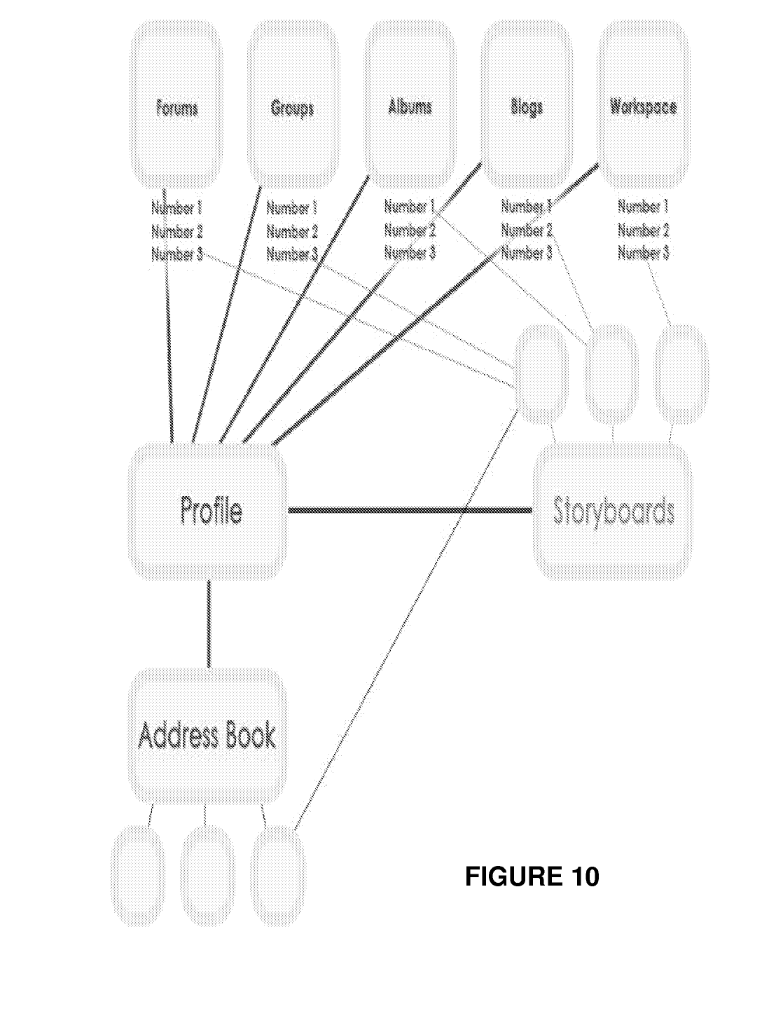

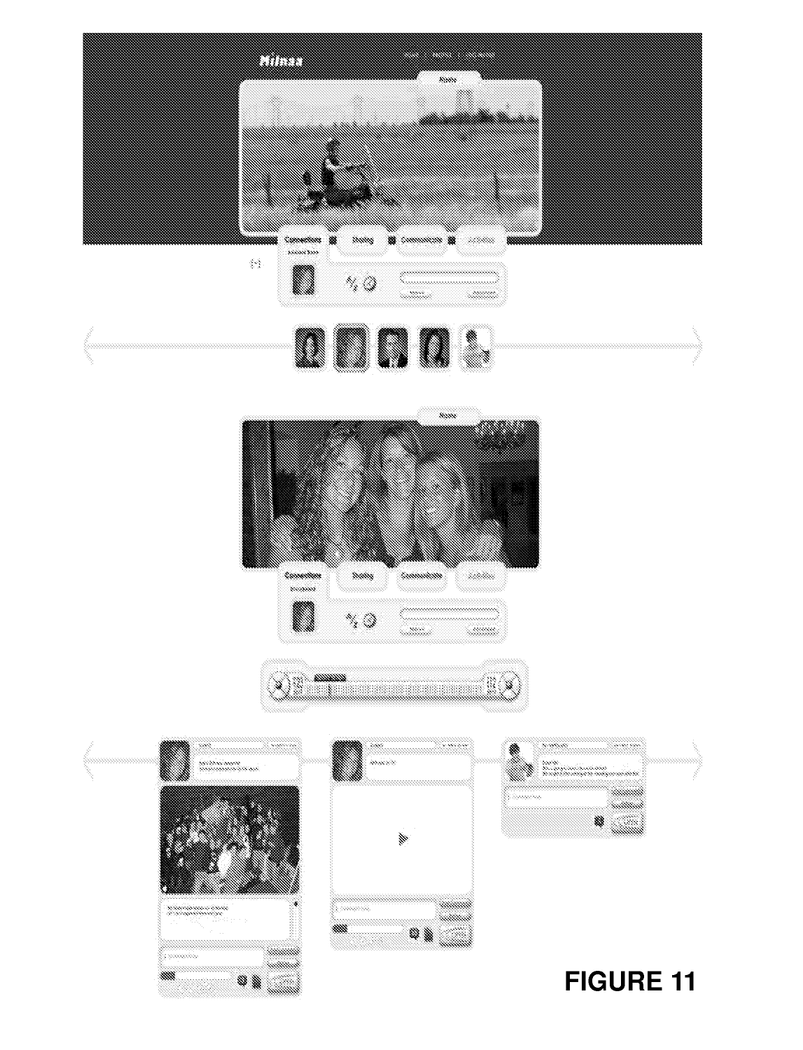

FIG. 10 illustrates a relationship between the story board system and a user profile. In particular, the storyboard system is fully integrated inside the Milnaa social network software. The correlation between Milnaa Profile of a User and the interaction with Storyboard is shown in FIG. 10. FIG. 11 illustrates usage of the story board component in a larger system for social networking in which the Story board functionalities are integrated into the Milnaa software, which plays as the key element to access any Profile or its contacts and other details.

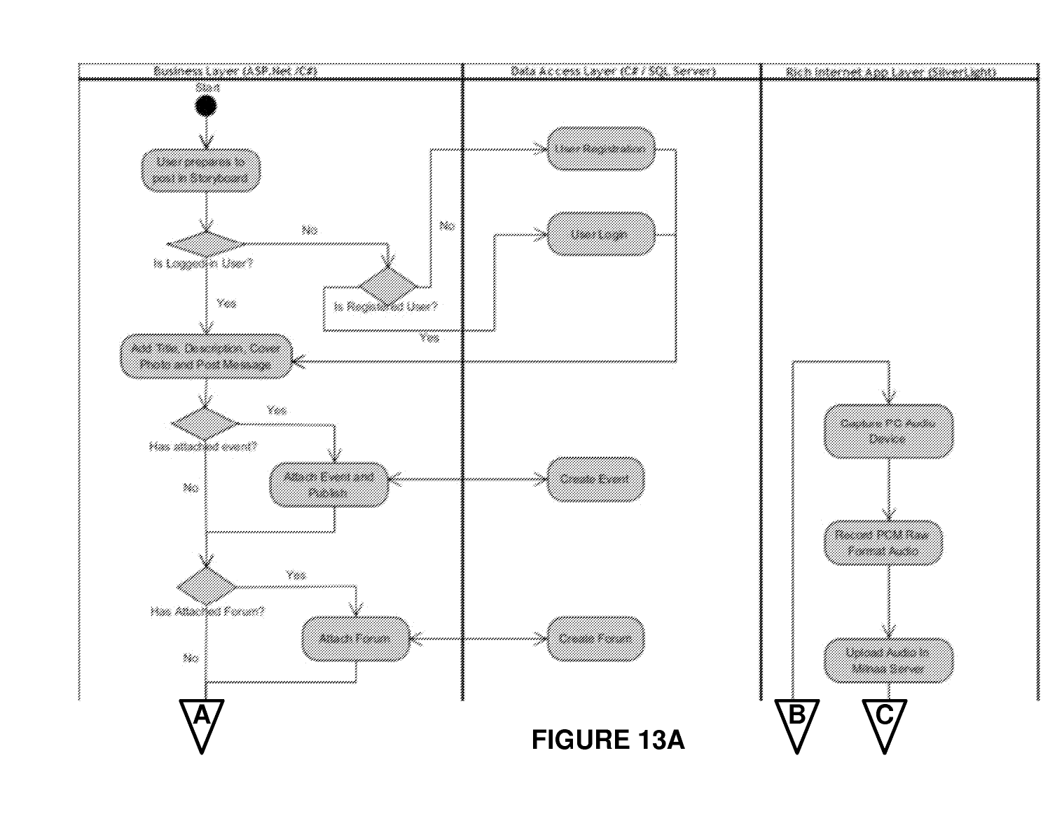

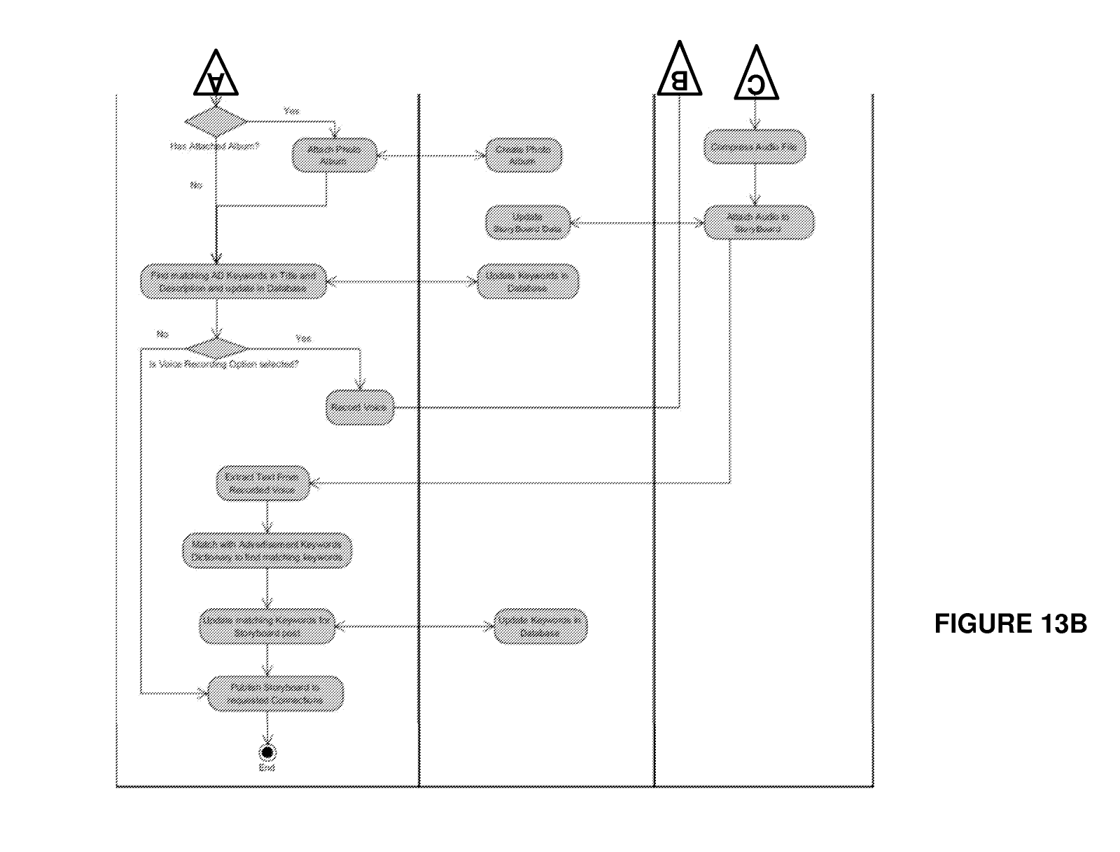

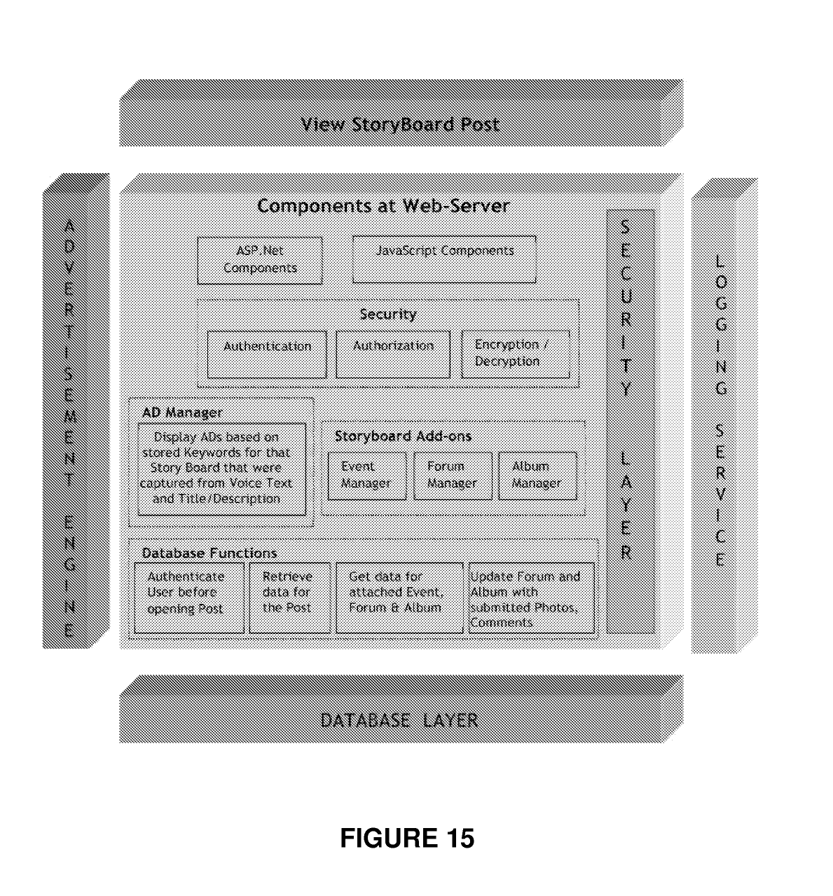

FIGS. 13A and 13B illustrate an activity data flow of the story board system. In particular, the involved logical processes between different layers of technology implementations (FIGS. 12 and 14). FIGS. 13A and 13B contain the complete logic flow for all functionalities of the entire process of a Post and related Advertisement intelligence parts. FIG. 15 illustrates a set of functional modules of the story board system used while opening a post in the story board system.

Advertising Intelligence

The storyboard system is created with its built-in intelligence to target right Advertisement sectors at the time of creation of a Post. This is done to be able to provide Picture and Audio advertisements while displaying a post without revealing any personal details of the owner of the post.

Capturing Advertisement Keywords from Post Title and Description

Storyboard title and description carries the major information about the post and also about the event. The Advertisement Intelligence engine processes the text of those two fields, the Title and Description parts of the Post against a Dictionary with pre-filled AD keywords and tries to find as many matches as possible.

The corresponding matching keywords are updated in the database against that particular Post. Following that whenever that Post is opened up in the Storyboard viewer, Image-based advertisement based on those Keywords are displayed on that page. In addition, if there is any voice memo to that Post, a related Audio advertisement, specifically filtered on particular AD Keywords is played after the Voice memo.

Capturing Advertisement Keywords from Voice Memo of the Post

A portion of capturing Advertisement keywords is done using the voice memo attached to a post. Using “Microsoft Speech SDK” the textual part of the voice memo is extracted. Once the text is extracted the AD Intelligence engine matches that text against a Dictionary with pre-filled AD keywords and tries to find as many matches as possible. Following that the matching keywords are updated in the database for that Post. Then whenever that post opens up in the Storyboard viewer, Image-based Ads are displayed depending on those stored Keywords. In addition, a related Audio Ad, filtered on those stored Keywords is played, after playing the Voice memo.

### EXAMPLE

For the purposes of an example, assume that there is a post by someone on a birthday party and the post looks like below:

Title: “Birthday Party of Bob”

Description: “On June 30^{th} we are going to celebrate birthday party of Bob on boat”

Voice Memo: “Hi there, please come and join us on San Francisco bay where we are going to party whole night and will have lot of fun and good food and drinks . . . ”

Based on the above texts, the AD Intelligence Engine would try to match those words against the existing AD keywords that it has in its Dictionary. The Dictionary that the AD Intelligence Engine maintains gets constantly updated based on new Ads created in the system.

In the example, assume that the AD intelligence engine found matches on following words:

“Birthday”, “Party”, “Boat”, “San Francisco Bay”, “Food”, “Drinks”, “30^{th} June”

These matches will be updated in the database for that particular post. Then, whenever anyone opens that post, Pictorial and Audio Ads based on those Keywords will be placed in the page/web page/user interface presented to the user.

In the example, assuming that the Milnaa System has the following Ads active:

Ad by San Francisco Bay Boat Rental

Ads of Restaurants near San Francisco Bay

Deals in San Francisco as on June 30^{th}

Ads by Stores on special Birthday Gifts

And so on . . .

For any Picture and Audio ADs on Food or Birthday or Party or Boating, or Purchases, or on areas near San Francisco will be displayed when that post gets opened.

While the foregoing has been with reference to a particular embodiment of the invention, it will be appreciated by those skilled in the art that changes in this embodiment may be made without departing from the principles and spirit of the disclosure, the scope of which is defined by the appended claims.

1. An apparatus comprising:
a computer implemented story board system;
one or more computing devices that are coupleable to the computer implemented story board system over a link;
the story board system having storyboard engine that permits each computing device to make a post to a storyboard wherein the storyboard has a plurality of posts, view the storyboard and open a specific post of the storyboard; and
the story board engine generates a scrollbar for each storyboard that allows the computing device to browse each of the posts in a particular storyboard.

2. The apparatus of claim 1, wherein the story board system further comprises an adverting intelligence engine that matches a set of information in the post to select one or more advertisements to display to the computing device.

3. The apparatus of claim 1, wherein each computing device is a processing unit based device having a processor, a memory, connectivity circuits and a display.

4. The apparatus of claim 3, wherein the processor of each computing device executes an application resident on computing device to interact with the storyboard system.

5. The apparatus of claim 1, wherein the story board engine further comprises one or more computer resources.

6. The apparatus of claim 1, wherein the story board engine further comprises an ASP.net portion, a Javascript portion and a Silverlight portion.

7. The apparatus of claim 1, wherein the storyboard engine further comprises access control component that permits a user to control access to a storyboard of the user.

8. The apparatus of claim 7, wherein the access control component generates an access list based on an address book of the user.

9. The apparatus of claim 1, wherein the post is one of an event, a forum, a comment, an album, web-link, a group, a text, an audio, a video, a 3D file and a link to a workspace.

10. The apparatus of claim 1, wherein the storyboard engine generates a home page, wherein the home page has one or more public storyboards that scroll across the home page.

11. The apparatus of claim 1, wherein each computing device has a recording device to record a piece of multimedia for a post.

12. A method comprising:
providing a computer implemented story board system and one or more computing devices that are coupleable to the computer implemented story board system over a link;
making, by a computing device, a post to a storyboard stored in the story board system;
viewing, by a computing device, a storyboard stored in the story board system;
opening, by a computing device, a particular post in a storyboard stored in the story board system; and
generating, by the story board system, a scrollbar for each storyboard that allows the computing device to browse each of the posts in a particular storyboard.

13. The method of claim 12 further comprising generating, by an adverting intelligence engine, one or more advertisements to display on the computing device based on a set of information in the post.

14. The method of claim 12 further comprising controlling access, using an access control component, to a storyboard of the user.

15. The method of claim 14, wherein controlling access further comprises generating an access list based on an address book of the user.

16. The method of claim 12, wherein the post is one of an event, a forum, a comment, an album, web-link, a group, a text, an audio, a video, a 3D file and a link to a workspace.

17. The method of claim 12 further comprising generating, by the storyboard engine, a home page wherein the home page has one or more public storyboards that scroll across the home page.

18. The method of claim 12 further comprising performing a one touch multimedia recording using a recording device of the computing device.
